(19) United States
(12) Patent Application Publication
(10) Pub. No.: US 2005/0026116 A1
(43) Pub. Date: Feb. 3, 2005

(54) Process to prevent fracture of endodontically treated teeth during post placement

(76) Inventor: Jeffery A. Ketzler, Biddeford, ME (US)

Correspondence Address: Jeff Ketzler, Suite 2, 115 Main St, Biddeford, ME, 04005, US

(21) Appl. No.: 10/629,748

(22) Filed: Jul. 30, 2003

(51) Int. Cl. A61C 5/08

(52) U.S. Cl. 433/220

(57) ABSTRACT

A Process to Prevent Fracture of Endodontically Treated Teeth During Post Placement in restoring these teeth is created when a sleeve made of metal or other machined materials; whose constant inner and variable, to match varying post spaces, outer diameters are threaded, is first passively cemented into the post space of a human tooth root's pulp canal after endodontic treatment. Then a matching, integrally threaded post made of an identical material that has a single side slot running from its tip to its coronal portion; which portion can accept a second integrally threaded, matching sleeve for anchorage and contains two parallel sided flat areas traversed by cross holes, is rotated through such a sleeve until it contacts endodontic filling material and is subsequently held in place with cement. Post insertion, that is: rotation through sleeve until contact with endodontic filling material and subsequent cementation, is accomplished using a knurled delivery tool with a matching, internally threaded shank that accepts such a post.

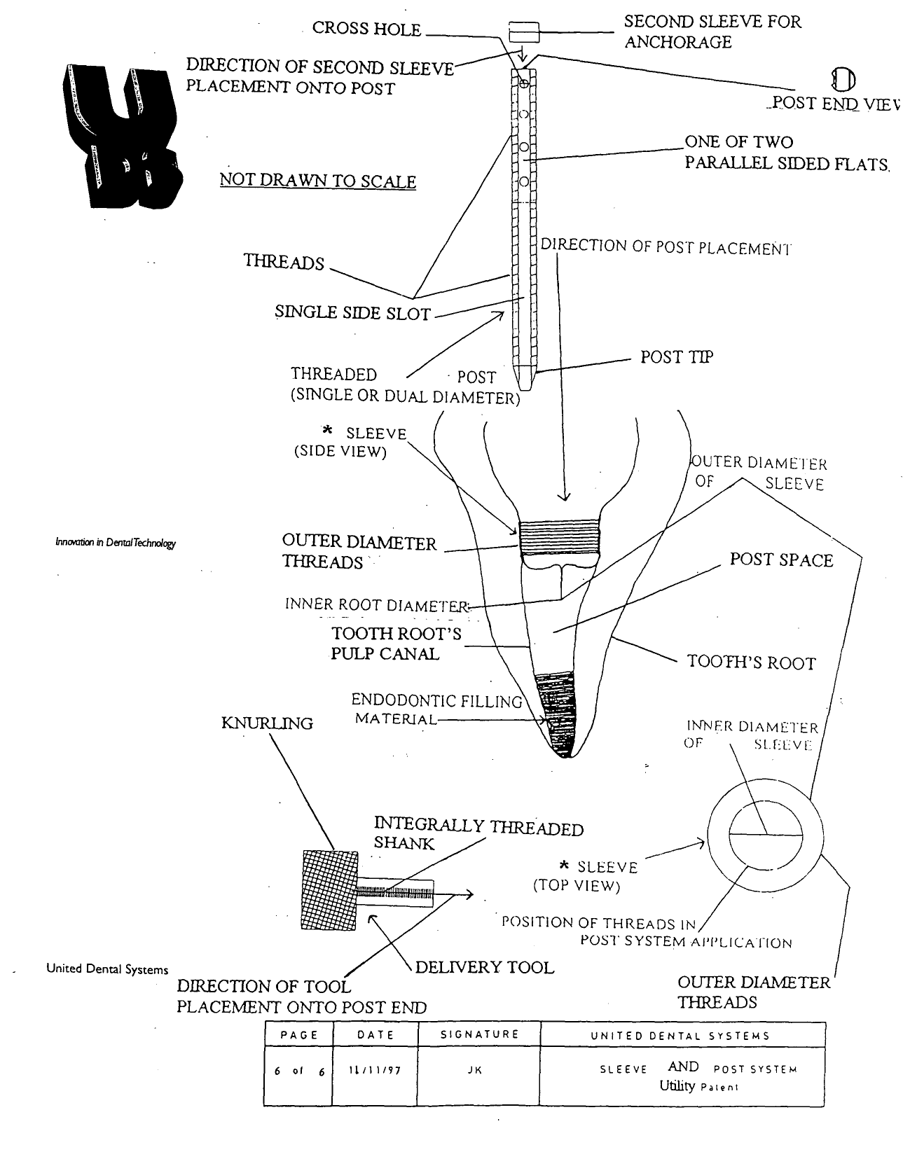

This Document is an application for a utility patent as offered by the U.S. patent and Trademark office.

### HISTORY OF PROCESS

Posts that anchor the coronal replacement material for endodontically treated human teeth to remaining root structure are needed for restoring these teeth and incidences of iatrogenic root fracture during post placement are well documented in the dental literature.ⁱ Also, due to removal of tooth structure that occurs during endodontic treatment, endodontically treated human teeth are predisposed to root fractures of this type.ⁱⁱ

### DESCRIPTION OF DRAWING

Enclosed please find an 8.5″×11″ drawing entitled “Sleeve and Post System” showing the specifications of the items described.

### DESCRIPTION OF INVENTION

A Process to Prevent Fracture of Endodonticall Treated Teeth During Post Placement in restoring these teeth is created when a system using a sleeve made of metal or other machined materials; whose constant inner and variable, to match varying post spaces, outer diameters are threaded, is first passively cemented into the post space of a human tooth root's pulp canal after endodontic treatment. Then a matching, integrally threaded post made of an identical material, that has a single side slot running from its tip to its coronal portion; which portion can accept a second integrally threaded, matching sleeve for anchorage and contains two parallel sided flat areas traversed by cross holes, is rotated through such a sleeve until it contacts endodontic filling material and is subsequently held in place with cement. Post insertion, that is: rotation through sleeve until contact with endodontic filling material and subsequent cementation, is accomplished using a knurled delivery tool with a matching, internally threaded shank that accepts such a post.
ⁱDeutsch a, Cavatari J, Musikant B. et al: Root fracture during insertion of prefabricated posts related to root size. J Prosthet Dent 53:786-789, 1985.

ⁱⁱRoss IF: Fracture susceptibility of endodontically treated teeth. J Endod 6:560-565, 1980.

1. Leaving the inner diameter of the sleeve constant allows for the use of a single diameter of the post in most situations reducing the cost of the system. In cases of unusually large post spaces, a second and larger diameter of the post with an accompanying larger inner diameter of the sleeve would be needed.

2. The post's single side slot running from its tip to one of the flat areas on its coronal portion is filled with cement during the cementation process that facilitates fixture of the post into the pulp canal's post space thus preventing rotational displacement of the post.

3. Threading of the post's entire length along with threading the outer diameter of the sleeve increases the amount of surface area available for adhesive cementation thus enhancing retention of the entire system.

4. Having multiple cross holes running over the coronal portion of the post for integration of flowable composite resin coronal replacement material and being able to place the integrally threaded and matching second sleeve for anchorage of silver amalgam coronal replacement material at any position along the post allows for the manufacture of a single length of the post to be cut chairside by a dentist to a length fitting a particular case, greatly increasing the convenience of the system.

5. Use of the delivery tool, with its internally threaded and matching shank that screws onto to the post, holds the post securely while it is being transported to the mouth for insertion through the sleeve into the post space thus preventing mishandling of the post that could result in its ingestion or aspiration by a dental patient.
